(19) United States
(12) Patent Application Publication
(10) Pub. No.: US 2014/0233751 A1
(43) Pub. Date: Aug. 21, 2014

(54) SPEAKER MECHANISM HAVING A CONFORMING CIRCUIT BOARD

(71) Applicants: John Cataldo, Westlake Village, CA (US); Daniel C. Sullivan, Santa Barbara, CA (US); Mardis Bagley, San Francisco, CA (US)

(72) Inventors: John Cataldo, Westlake Village, CA (US); Daniel C. Sullivan, Santa Barbara, CA (US); Mardis Bagley, San Francisco, CA (US)

(73) Assignee: HEADLOGIC LLC, Westlake Village, CA (US)

(21) Appl. No.: 13/770,154

(22) Filed: Feb. 19, 2013

(51) Int. Cl. H04R 1/10

(52) U.S. Cl. CPC H04R 1/1033
USPC 381/74

(57) ABSTRACT

A device removeably attachable to a case for an electronic device for delivering sound includes a housing having a speaker means and a printed circuit board assembly mounted in the housing. The printed circuit board assembly is in electronic communication with the speaker means. The printed circuit board assembly includes a wireless communication module having an antenna to enable wireless communication with the electronic device. The printed circuit board and having a curved shape to partially circumscribe the speaker means to enable the speaker means and the circuit board to lie co-planar. In one embodiment, the speaker means is a retractable ear bud device. In another embodiment, the speaker assembly is a speaker with an annular periphery and a body with a truncated conical shape, whereby the printer circuit board lies co-planar with a portion of the body of the speaker.

### RELATED APPLICATIONS

This patent application relates in subject matter to commonly assigned U.S. patent application Ser. No. 13/733,886 filed 4 Jan. 2013, Ser. No. 13/733,360 filed 2 Jan. 2013, Ser. No. 13/621,332 filed 17 Sep. 2012, and Ser. No. 13/733,574 filed 3 Jan. 2013, the disclosures of which are incorporated herein by reference.

### FIELD OF THE INVENTION

The present invention relates to speaker mechanisms having wireless communication capability.

### BACKGROUND OF THE INVENTION

Ear buds are devices that attach to the ear or head of a user to deliver sound directly to the ear in a personal way. Ear buds may attach to the pinna, lobule, or insert within the external auditory canal. Ear buds may also hang from the head and cover a portion of the ear. The sound delivered typically can be heard by the user, but others have difficulty hearing at the typical sound volume delivered.

One benefit of using ear buds is that an electronic device may be distanced from a user's ear to minimize electro-magnetic fields, which are known to impair the electrical fields in the brain, sometimes causing headaches or heat buildup in the head. Another benefit is to minimize interference with ambient sounds. Yet another benefit is to minimize eavesdropping. Since an ear bud need not be held by a user, this frees the hands for other activities.

Ear buds are commonly used with telephones, music players, computers and other portable, and non-portable, electronic devices.

One major drawback of using wired ear buds with electronic devices is cord management. Cord management is a commonly experienced problem where the cord of the ear buds becomes tangled. Ear bud cords may be damaged by a frustrated user who attempts to hastily untangle the cord. Operating an automobile or other vehicle while experiencing cord management problems can be dangerous. What is desired is a better way of cord management which enables the user to readily extend and retract ear bud cables in an easy and reliable manner. Moreover, it should also be sleek and as thin as possible for keeping in unobtrusively.

CN101959097 assigned to Nantong Xining Design Service Co., Ltd., discloses an audio receiver for an earphone device that attaches to clothing. The receiver receives wireless signals and includes an earphone socket. The wireless signals are communicated via the earphone socket to earphone. This enables a remotely located electronic device to broadcast to the receiver, and the user to employ earphones to hear the broadcast. The earphone cables are stored in the receiver. Unfortunately, the cord management problem is not fully resolved.

U.S. Pat. No. 8.047,365 to Lin et al. discloses a folding case that has one side for holding an electronic device and another side that magnetically secures ear buds. The folding case includes electrical connections between the ear buds and the electronic device. The magnetic connection helps with ear bud management, and inhibits damage to the cord.

While the state of the art shows a trend toward convenience of use of ear buds with electronic devices and cases for electronic devices, there is also a lack of effective ways for managing ear bud cables. What is desired is a way of managing ear bud cables that is convenient, safe and durable.

There is also a need for smaller and more functional and reliable devices having ear buds, or other speaker mechanism. Therefore, it is desirable that any retractable ear bud assembly, or other speaker mechanism, be as small as possible.

### SUMMARY OF THE INVENTION

A retractable ear bud device includes a case for mounting a retraction mechanism for selectively retracting and dispensing the ear bud cable, an ear bud cable wound on a rotatable spool in the retraction mechanism. The ear bud cable having a free end provided with at least one ear bud and the other end in communication with an electronic device enabled with wireless audio output capability. The retractable ear bud device includes a printed circuit board assembly (PCBA) housing a Bluetooth™ communication module having a radio and a processor, the PCBA configured to wrap around the rotatable spool and co-planar with the rotatable spool to minimize the height of the device.

The radio transmits and receives audio signals via a host-less Bluetooth™ communication protocol, the electronic device being in electronic communication with the ear bud cable to communicate audio signals to the ear bud.

The ear bud cable comprises a fixed end hard-wired to the PCBA to establish a hard-wired electrical connection between the ear bud cable and the retractable ear bud device.

The ear bud cable is configured as a flat cable to minimize tangles and to maximize stowage capacity of the rotatable spool

The ear bud cable is configured fitted with a microphone to enable telephonic communication between the microphone and the electronic device.

In one embodiment, the retraction mechanism includes a rotatable spool, a retainer for housing the rotatable spool, and an ear bud cable having a middle portion wrapped around the rotatable spool to enable the ear bud cable to be selectively retracted and dispensed when the rotatable spool rotates.

The rotatable spool has a top level and a bottom level and the rotatable spool defines a slot to enable the ear bud cable to extend between the top level and the bottom level.

The invention includes a rechargeable battery is mounted in the housing and in electrical connection with the electronic device to power the PCBA, and a charging port electrically connected with the rechargeable battery and mounted on the case.

A volume control switch is mounted on the housing for regulating audio output of the ear buds, the volume control switch including an up volume actuator, a down volume actuator and a skip actuator. The case comprises the housing for holding an ear bud cable, the housing being attachable to the case.

The housing has clips for removeably attaching the housing to the case, the case is configured for holding the electronic device. A hinged cover is mounted on the housing for covering the ear bud when the ear bud is retracted.

The printed circuit board assembly (PCBA) houses Bluetooth circuitry and other audio circuitry, and is also configured with an antenna, such as a Bluetooth radio antenna wrapping around the rotatable spool of the retractable mechanism.

The retraction mechanism includes a spool rotatably mounted in the housing, a spring mounted centrally within the spool, and an annular retainer circumscribing the spool to align the ear bud cable on the spool.

The spool has a top level, a bottom level, and a slot defined between the top level and the bottom level, the top level stores a first portion of the ear bud cable, and the bottom level stores a second portion of the ear bud cable and the slot enables the ear bud cable to feed between the top level and the bottom level.

The housing comprises a pawl latch and switch assembly having a pawl latch and a switch configured as a unitary structure, the switch selectively disengages the pawl latch from the rotatable spool and cooperates therewith to inhibit retraction of the ear bud cable, the actuation of the switch releases the pawl latch from the rotatable spool to enable retracting and stowing the ear bud cable on the rotatable spool.

Typically, the pawl latch and switch assembly further comprises an actuator spring to bias the pawl latch and switch assembly in a locking orientation to inhibit retraction of the ear bud cable and counter-rotation of the rotatable spool and by switch actuation, the paw latch releases from the rotatable spool to enable the spring to counter rotate the rotatable spool to retract the ear bud cable.

In one embodiment, the electronic device includes a telephone or a music player smart phone having audio output capability.

In an alternate embodiment, the electronic device includes a tablet computer or a computing device having audio output capability.

The printed circuit board assembly (PCBA) houses Bluetooth circuitry and other audio circuitry and is configured with a Bluetooth antenna wrapping around the rotatable spool of the retractable mechanism, the PCBA lying co-planar with the rotatable spool of the retraction mechanism.

### BRIEF DESCRIPTION OF THE DRAWINGS

The present invention is described in terms of various examples as set forth in the drawings, in which:

FIG. 1 is a perspective view of a retractable ear bud mechanism attached to a case for an electronic device in accordance with the present invention.

FIG. 2 is a perspective view of the retractable ear bud mechanism having a hinged cover in a closed configuration.

FIG. 3 a perspective view of the retractable ear bud mechanism of FIG. 2 having the hinged cover in an open configuration.

FIG. 4 is a partial perspective view of the ear buds 22a, 22b shown pulled out of the case of the electronic device shown in FIG. 1.

FIG. 5 is a perspective view of the retractable ear bud mechanism attached to a case shown in FIG. 1 after removing the hinged cover and housing.

FIG. 6 is an exploded perspective view of a case for an electronic device and a speaker assembly.

FIG. 7 is a partial exploded perspective view of the speaker assembly of FIG. 6.

### DETAILED DESCRIPTION

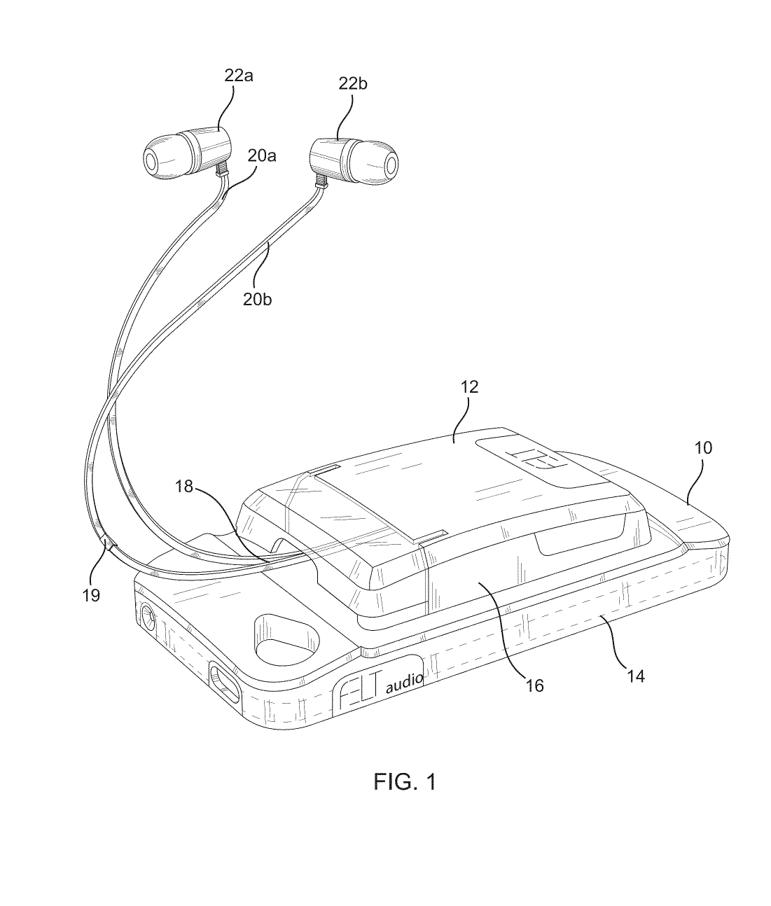

FIG. 1 shows a case 10 in accordance with the present invention and an ear bud module 12. The ear bud module 12 removeably attaches to the case 10. The case 10 holds electronic device 14 having an audio output capability. The electronic device 14 is preferably a telephone, the music player smart phone, a tablet computer, or other computing device having audio output capability.

In a preferred embodiment, the electronic device 14 is enabled with wireless audio output capability, for example a Bluetooth™ communication module having a radio and a processor, where the radio transmits and receives audio signals via a host-less Bluetooth™ communication protocol such as defined by the trade organization, Bluetooth SIG, and other trade organizations.

The ear bud module 12 removeably attaches to the case 10. This removable attachment can include a clipped attachment that includes a press-fit between the ear bud module 12 and the case 10. In an alternate embodiment of the invention the ear bud module 12 slidably connects to the case 10. The use of a user actuated switch supplements the press-fit and slideable connection between the ear bud module 12 and the case 10 to enable a locking connection between the case 10 and the ear bud module 12.

The ear bud module 12 includes a housing 16 and an ear bud cable 18, which retractably holds an ear bud cable 18. The ear bud cable 18 has free ends 20a and 20b and ear buds 22a and 22b attached to the free ends 20a and 20b, respectively.

In one embodiment, the ear bud cable 18 is equipped with a microphone 19 to enable telephonic communication between the microphone 19 and an electronic device.

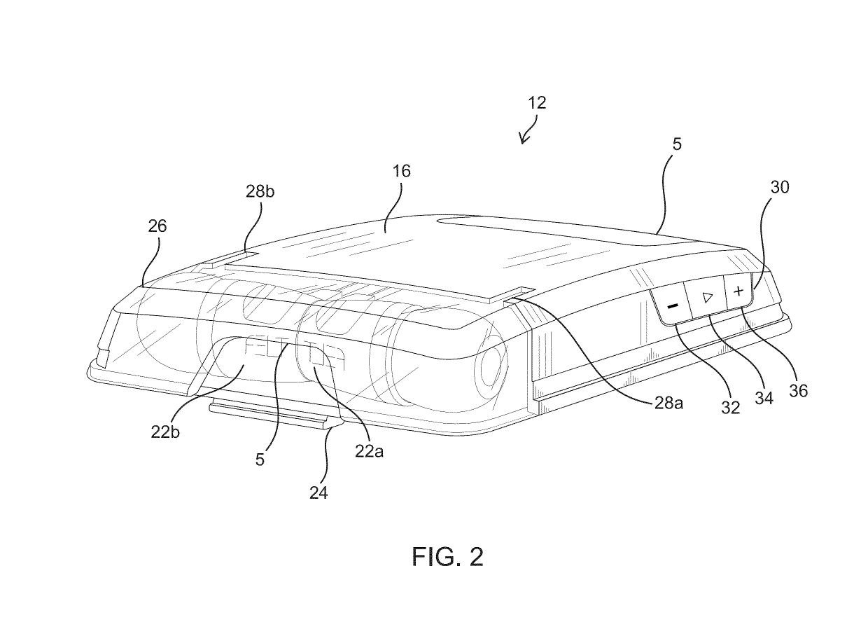

FIG. 2 shows the ear bud module generally designated with the reference numeral 12. The ear bud module 12 includes at least one clip 24 for removeably attaching the ear bud module 12 to a case. Preferably, the ear bud module 12 has more than one clip 24. The ear buds 22a and 22b are shown in a retracted configuration.

The ear bud module 12 has a cover 26 mounted on the housing 16 for covering the ear buds 22a and 22b when the ear buds 22a and 22b are retracted. The cover 26 is shown closed on the housing 16. The cover 26 has two hinges 28a and 28b that assure alignment of the cover 26 on the housing 16 when the cover 26 is closed, and to enable the cover 26 to open. Preferably the cover 26 is made from transparent material to reveal the ear buds 22a and 22b when the cover 26 is closed.

The housing 16 includes a control switch 30, which includes a down volume actuator 32, and up volume actuator 36 and a skip actuator 34. The volume actuators regulate the volume of sound communicated to the ear buds 22a and 22b. The skip actuator 34 enables a user to selectively bypass an audio file when a series of audio files are streamed to the ear bud module 12 from an electronic device.

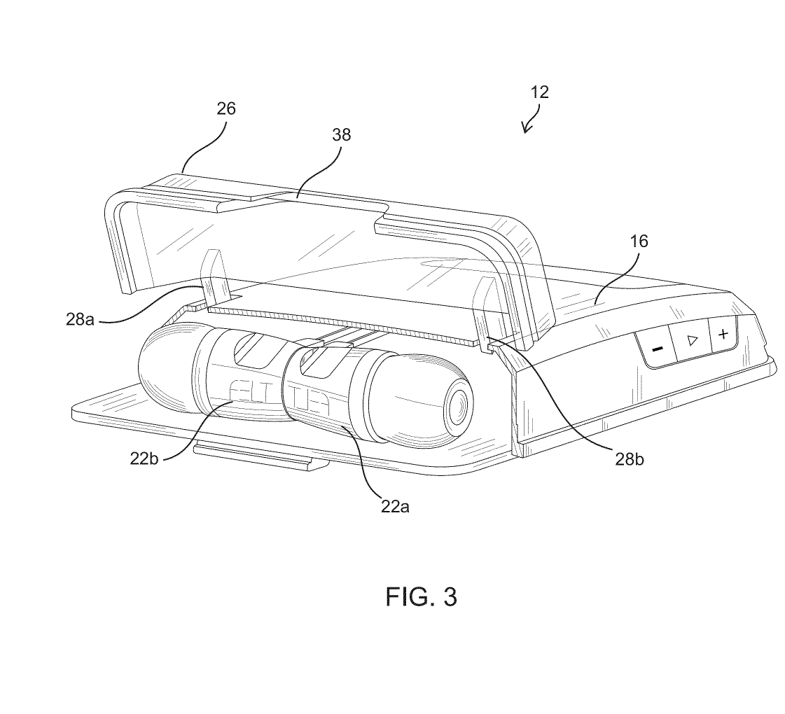

FIG. 3 shows the ear bud module 12 with the cover 26 open. The cover 26 has a handle 38 to enable a user to open and close the cover 26. As shown the handle 38 includes a recess defining an opening in the cover 26 sized to enable the finger of a user to insert into the cover 26 to grip and open the cover 26. The hinges 28a and 28b restrict the cover 26 when it opens and limit the cover opening to approximately a 90 degree angle with respect to the housing 16. Restricting the angle of the cover 26 when it opens enables the hinges 28a and 28b to be shaped so the hinges 28a and 28b only minimally protrude into the housing 16 during movement. Thus the hinges 28a and 28b are designed to minimize potential interference between the cover 38 and the ear buds 22a and 22b.

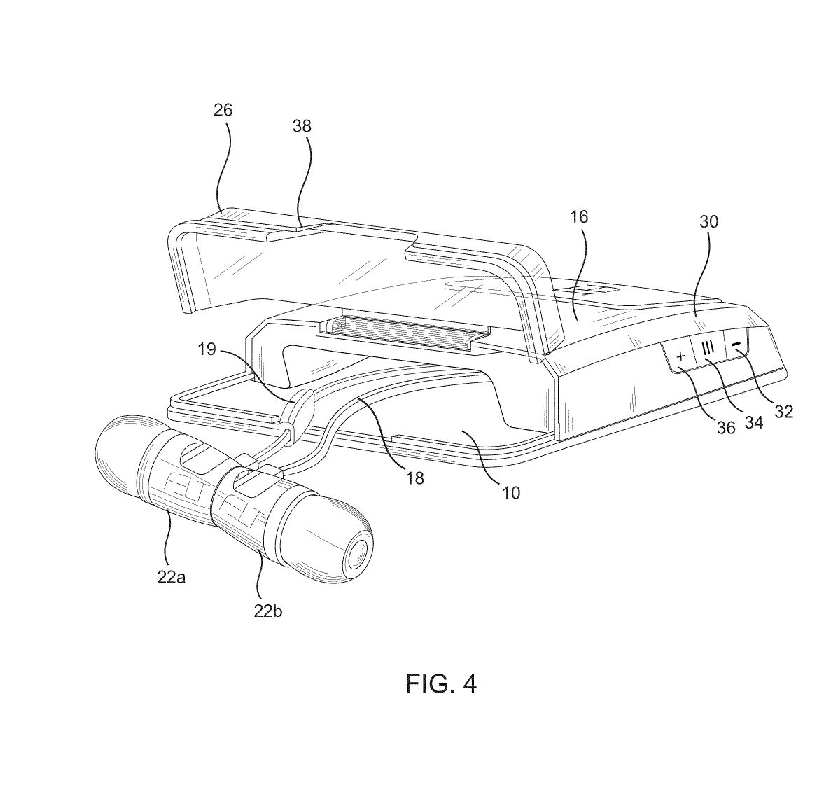

FIG. 4 is a partial perspective view of the electronics device 14 (not shown) of FIG. 1 housed inside the case 10 protected by a housing 16 provided with a hinged cover 26. The ear buds 22a, 22b fixed with a microphone 19 on the ear bud cables 18 are shown pulled out of the case 10 through the opening 38 provided in the hinged cover 26 which is kept opened for this purpose. The down volume actuator 32 and up volume actuator 36 and a skip actuator 34 are also visible to be provided on control switch 30.

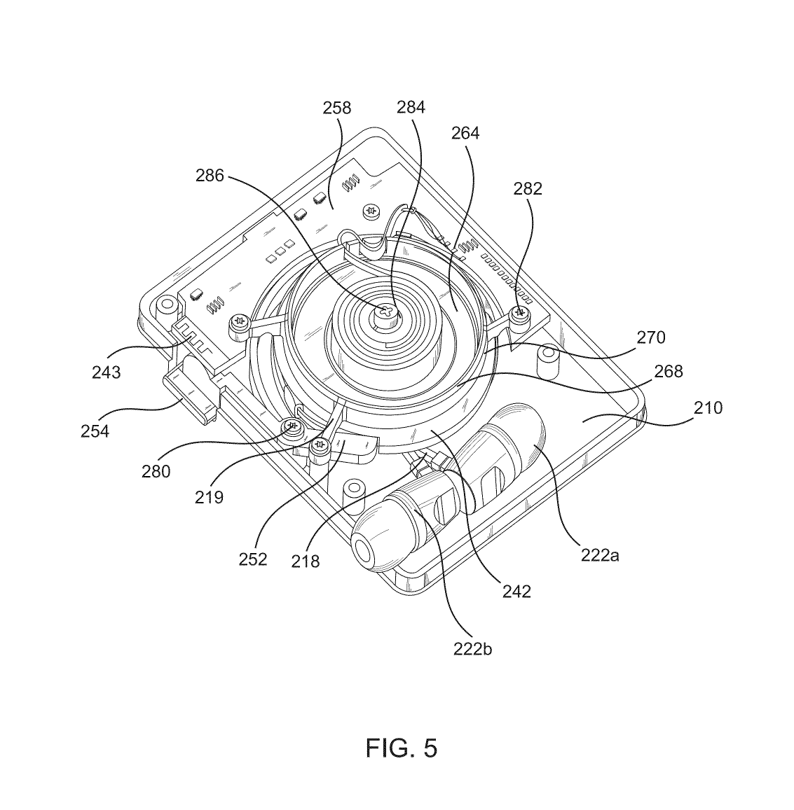

FIG. 5 is another embodiment of the retractable ear bud mechanism shown in FIG. 1 assembled on base 215 after removing the hinged cover and the housing. It shows a sleek printed circuit board assembly (PCBA) 258 housing a Bluetooth circuitry and other audio circuitry. This PCBA is also configured with a BT antenna 243 to wrap around the spool 242 of the ear bud mechanism including retractable ear buds 222a and 222b connected at one end of the ear bud cable 218. The other end of the ear bud cable 218 is connected to the PCBA 258. This embodiment is particularly compact and sleek because of the PCBA 258 lies co-planar with this spool 242 to minimize the height of the overall device shown in FIG. 4. The ear bud module 12 includes an ear bud retraction mechanism having a rotatable spool 242 housed inside a retainer 270 which is fixed in position on base 215 by means of screws 288. Normally, the ear bud cable 218 is configured as a flat cable to minimize tangles and to maximize stowage capacity of the spool 242.

The pawl latch 252 and switch 254 assembly normally engages the spool 242 to enable it to extend a desired length of ear bud cable 218. The pawl latch and switch assembly includes a pawl latch 252 and a switch 254. The switch 254 selectively disengages the pawl latch 252 from the spool 242. The spool 242 includes a notch (not seen) that normally engages with the pawl latch 252 and cooperates with it to inhibit retraction of the ear bud cable 218. Actuation of the switch 254 releases the pawl latch 252 from the spool notch to enable the spool 242 to retract and stow the ear bud cable 218.

The pawl latch 252 and the switch 254 are configured as a unitary structure to form the pawl latch and switch assembly, which pivotally mounts in the case 215. The pawl latch and switch assembly also includes an actuator spring and screw (not seen) that cooperate to bias the pawl latch and switch assembly in a locking orientation to inhibit retraction of the ear bud cable 218 and counter-rotation of the spool 242. Counter-rotation of the spool 242 retracts the ear bud cable 218. Actuation of the switch 254 releases the paw latch 252 from the spool notch to enable the spring to counter-rotate the spool 242 and thus enable retraction of the ear bud cable 218.

The case 215 includes an axel 282 (not seen) that is formed in the case 215 to receive the spool 242. A screw 286 and retainer 284 cooperate to screw the spool 242 on the axle 282 to hold it in a fixed axial orientation, while enabling the spool 242 to rotate about the axel 282.

The spool 242 defines a slot 268 that enables the ear bud cable 218 to extend through the spool 422. The slot 268 has a spiral shape to enable the ear bud cable 218 to extend through the spool 242 from a top level 264 to a bottom level of the spool 242. The spiral shape enables the ear bud cable 218 to form slack that readily slides through the slot 268 when the ear bud cable 218 is dispensed and retracted. The spool 242 also includes a recessed portion on the bottom level of the spool 242 which holds a spring (not seen). The spring is recessed in the spool 242 to minimize height of the case 215. A portion of the ear bud cable 218 wraps around the bottom level of the spool 242 and circumscribes this spring. The arrangement of the ear bud cable 218 circumscribing the spring on the bottom level of the spool 242 also minimizes height of the ear bud module.

The ear bud cable 218 has a fixed end 268 that is hard wired to the circuit board 258 to assure integrity of the audio signals communicated from the wireless receiver of the circuit board 258 to the ear buds 222a and 222b. Preferably, the hard wired connection between the circuit board 258 and the fixed end 268 is a solder joint. Although, a hard wired connection between the fixed end 268 of the ear bud cable 218 and the circuit board 258 is described, alternate connections are possible; including a plug or other mechanism for interconnecting an ear bud cable 218 to a circuit board 258 that assures signal integrity can be used.

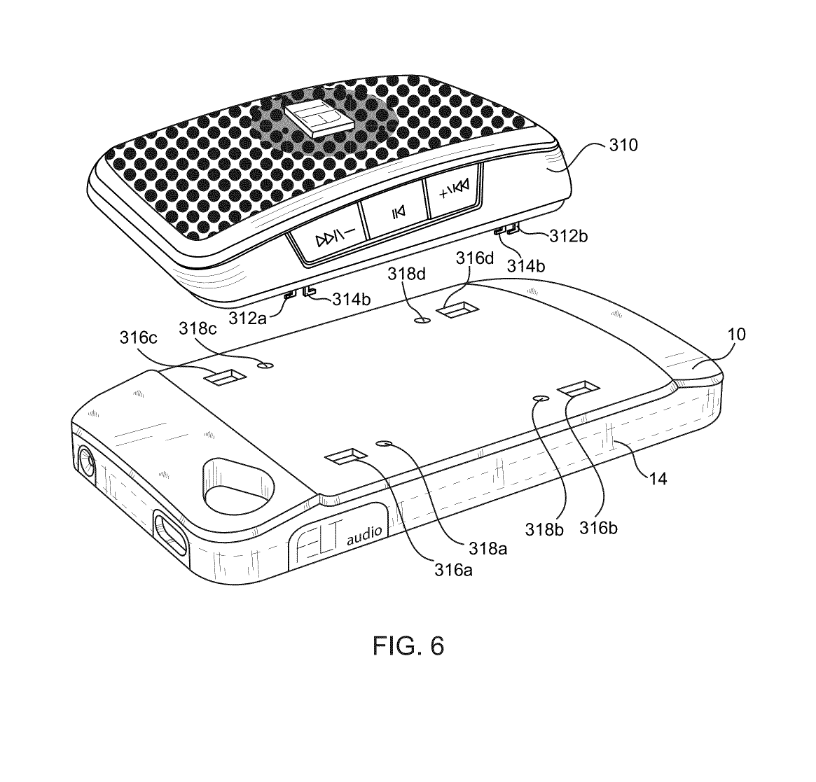

FIG. 6 shows a speaker assembly 310 in an exploded view from a case 10 of an electronic device 14 in accordance with the present invention. The speaker assembly 310 includes an audio speaker having wireless communication capability for wirelessly communicating with the electronic device 14. The speaker assembly 310 removeably attaches to the case 10 for the electronic device 14. Preferably the electronic device, shown in hidden line view, is a portable smart phone.

The speaker assembly 310 includes feet 312a and 312 magnets 314a and 314b. The case 10 defines recesses 316a, 316b, 316c and 316d that enable the feet 312a and 312b to insert into the recesses 316a and 316b, respectively. Sliding the inserted feet 312a and 312b with respect to the case 10 locks the feet 312a and 312b in a press-fit within the recesses 316a and 316b, respectively. Additional feet insert into the recesses 318c and 318d.

The speaker assembly 310 also includes magnets 314a and 314b to align and hold the feet 312a and 312b with the recesses 316a and 316b, respectively. Accordingly, the magnets 314a and 314b cooperate with the feet 312a and 312b to maintain the speaker assembly 310 in a locking arrangement with the case 10. The case 10 also includes ferrous plates 318a, 318b, 318c and 318d to enable the magnets 314a and 314b, and other magnets, to magnetically hold the speaker assembly 310 on the case 10.

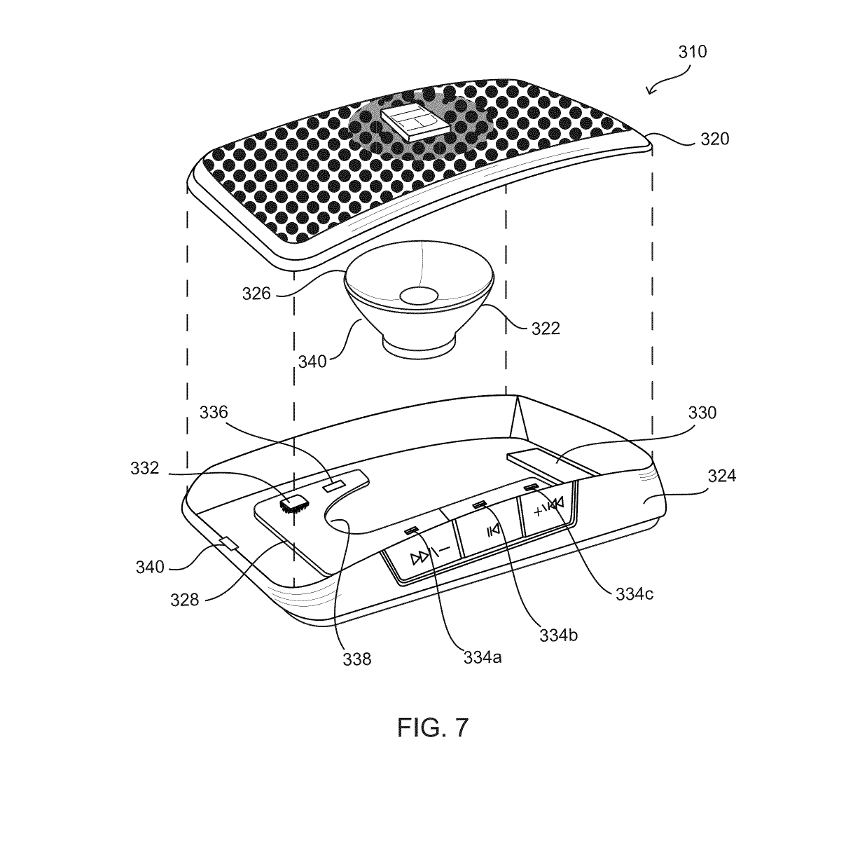

FIG. 7 shows a partially exploded view of the speaker assembly 310 having a cover 320, a speaker 322 and a housing 324. The cover 320 and the speaker 322 mount in the housing 324. The speaker 322 is an audio speaker having has a periphery 326 with annular shape, and a body 340 with a truncated conical shape. Minimizing the size and weight of the speaker assembly 310 is an important feature of the present invention.

The speaker assembly 310 further includes a printed circuit board assembly 328 and a battery 330. The battery 330 is rechargeable, mounts in the housing 324, and electronically connects with the printed circuit board assembly 328. The printed circuit board assembly 328 includes a wireless communication module 332, an antenna 336, and operation buttons 334a, 334b and 334c that control operation of the speaker assembly 310.

The printed circuit board assembly 328 mounts in the housing 324 to enable wireless communication with the electronic device 14 (FIG. 6). The printed circuit board assembly 328 includes a wireless communication module includes circuitry having amplification capability, a Bluetooth™ radio and an antenna 336. The printed circuit board assembly 328 has a side 338 having a curved shape to at least partially circumscribe the speaker 322. In particular, the side 338 of the printed circuit board assembly 328 lies co-planar with the body 340 of the speaker 322 when the speaker assembly 320 is assembled. The curved shape of the printed circuit board enables the speaker and the circuit board to lie co-planar in the housing to minimize housing size.

In an alternate embodiment, an 802.11x communication capability is included in the printed circuit board assembly 328 to enable the speaker assembly 310 to be operated via an electronic device within a wireless computer network.

In a preferred embodiment, the printed circuit board assembly 328 is the same design and shape as the printed circuit board assembly 258 and includes microphone circuitry to enable the speaker assembly 310 to function as a speaker and microphone assembly when the electronic device 14 is a portable phone. In this embodiment, the speaker assembly 310 includes a microphone 340 attached to the housing 324 in electronic communication with the printed circuit board assembly 328.

In yet another embodiment, the speaker assembly 310 and the ear bud module 12, and the case 10 are provided as a kit of parts. The speaker assembly 310 and the ear bud module 12 are interchangeably connectable to the case 10.

While the present invention is disclosed in terms of various embodiments, including preferred embodiments, it can be appreciated that the true scope of the invention is defined only by the appended claims.

1. A retractable ear bud device for selectively retracting and dispensing ear bud cable, comprising:
a housing for holding a retraction mechanism having a rotatable spool;
ear bud cable wound on the rotatable spool;
ear bud cable having a free end provided with at least one ear bud;
a printed circuit board assembly mounted in the housing and having a wireless communication module with a radio and a processor, the printed circuit board assembly is configured at least partially circumscribe the rotatable spool and electronically connects with the ear bud cable,
whereby the printed circuit board assembly lies co-planar with the rotatable spool to minimize the height of the retractable ear bud device.

2. The retractable ear bud device as set forth in claim 1, wherein the ear bud cable comprises a fixed end hard-wired to the printed circuit board assembly to establish a hard-wired electrical connection between the ear bud cable and the electronic device.

4. The retractable ear bud device as set forth in claim 1, wherein the ear bud cable is configured as a flat cable to minimize tangles and to maximize stowage capacity of the rotatable spool

5. The retractable ear bud device as set forth in claim 1, wherein the ear bud cable is configured fitted with a microphone to enable telephonic communication between the microphone and an electronic device.

6. The retractable ear bud device as set forth in claim 1, wherein the retraction mechanism comprises:
a rotatable spool;
a retainer for housing the rotatable spool; and
ear bud cable having a middle portion wrapped around the rotatable spool to enable the ear bud cable to be selectively retracted and dispensed when the rotatable spool rotates.

7. The retractable ear bud device as set forth in claim 6, wherein the rotatable spool has a top level and a bottom level and the rotatable spool defines a slot to enable the ear bud cable to extend between the top level and the bottom level.

8. The retractable ear bud device as set forth in claim 1 further comprising:
a rechargeable battery mounted in the housing and in electrical connection with the electronic device to power the printed circuit board assembly, and
a charging port electrically connected with the rechargeable battery and mounted on the case.

9. The retractable ear bud device as set forth in claim 1, further comprising a volume control switch mounted on the housing for regulating audio output of the ear buds, the volume control switch including an up volume actuator, a down volume actuator and a skip actuator.

10. The retractable ear bud device as set forth in claim 1, wherein the case comprises the housing for holding an ear bud cable, the housing being attachable to the case.

11. The retractable ear bud device as set forth in claim 10, wherein the housing has clips for removeably attaching the housing to the case, the case is configured for holding the electronic device.

12. The retractable ear bud device as set forth in claim 11 further comprising a hinged cover mounted on the housing for covering the ear bud when the ear bud cable is retracted.

13. The retractable ear bud device as set forth in claim 1, wherein the retraction mechanism includes a spool rotatably mounted in the housing, a spring mounted centrally within the spool, and an annular retainer circumscribing the spool to align the ear bud cable on the spool.

14. The retractable ear bud device as set forth in claim 13, wherein the spool has a top level, a bottom level, and a slot defined between the top level and the bottom level, the top level stores a first portion of the ear bud cable, and the bottom level stores a second portion of the ear bud cable and the slot enables the ear bud cable to feed between the top level and the bottom level.

15. The retractable ear bud device as set forth in claim 14, wherein the housing comprises a pawl latch and switch assembly having a pawl latch and a switch configured as a unitary structure, the switch selectively disengages the pawl latch from the rotatable spool and cooperates therewith to inhibit retraction of the ear bud cable, the actuation of the switch releases the pawl latch from the rotatable spool to enable retracting and stowing the ear bud cable on the rotatable spool.

16. A speaker for an audio speaker device having wireless communication capability, comprising:
a housing;
a speaker having an annular shape mounted in the housing;
a printed circuit board assembly mounted in the housing, the printed circuit board assembly including a wireless communication module having an antennae, the printed circuit board and having a curved shape to partially circumscribe the speaker;
whereby the curved shape of the printed circuit board enables the speaker and the circuit board to lie co-planar in the housing to minimize housing size.

17. The speaker as set forth in claim 16, wherein the housing has a means for attaching the speaker to a case for an electronic device to stow the speaker in contact with the electronic device.

18. A device removeably attachable to a case for an electronic device, comprising:
a housing;
a speaker means mounted in the housing;
a printed circuit board assembly mounted in the housing in electronic communication with the speaker means, the printed circuit board assembly including a wireless communication module having an antennae to enable wireless communication with the electronic device, the printed circuit board and having a curved shape to partially circumscribe the speaker means;
whereby the curved shape of the printed circuit board enables the speaker means and the circuit board to lie co-planar in the housing to minimize housing size.

19. A device as set forth in claim 18, wherein the speaker means is a retractable ear bud device.

20. A device as set forth in claim 18, wherein the speaker means is a speaker assembly having a speaker with an annular periphery and a body with a truncated conical shape, whereby the printer circuit board lies co-planar with a portion of the body of the speaker.
